(19) United States
(12) Patent Application Publication
(10) Pub. No.: US 2004/0154115 A1
(43) Pub. Date: Aug. 12, 2004

(54) Surgical instrument cleaning brush

(75) Inventor: Richard J. Schultz, Hudson, OH (US)

Correspondence Address: Thomas E. Young, Esq., Fay, Sharpe, Fagan, Minnich & McKee, LLP, Seventh Floor, 1100 Superior Avenue, Cleveland, OH, 44114-2518, US

(73) Assignee: SPECTRUM SURGICAL INSTRUMENTS, INC.

(21) Appl. No.: 10/749,755

(22) Filed: Dec. 30, 2003

Related U.S. Application Data
(60) Provisional application No. 60/437,306, filed on Jan. 2, 2003.

(51) Int. Cl. A46B 3/18; B08B 9/00

(52) U.S. Cl. 15/104.2; 15/206; 15/207.2

(57) ABSTRACT

An improved brush for cleaning surgical, medical and veterinary instruments adapted for cleaning tubes and passages is described. The improved brush comprises bristles captured between two helical wire segments with the bristles being antimicrobial.

This application claims priority of provisional application serial No. 60/437,306, filed Jan. 2, 2003.

### BACKGROUND OF THE INVENTION

This invention relates generally to cleaning brushes used in cleaning surgical and veterinary instruments and more particularly to long slim brushes used in cleaning interior passages and tubes in surgical and veterinary instruments.

Surgical and veterinary instruments are often complex in shape, expensive and include tubes, apertures or passages. Many surgical and veterinary instruments are reused. The instruments must be cleaned and sterilized between uses.

Brushes are often used in cleaning and sterilizing surgical and veterinary instruments. For instruments including interior passages or tubular instruments, relatively long slim brushes comprised of twisted wire retaining bristles near one end are often used. These brushes come in a multiplicity of sizes so as to facilitate cleaning instruments having different diameter passages. Because of the wide variety of tube sizes in surgical instruments, brushes come with diameters starting at approximately one millimeter and proceeding up to 10 millimeters and beyond. The number of diameters is large as, especially in the smaller sizes, the increment from one diameter to the next in a series may be less than one millimeter.

One type of conventional brushes used in cleaning surgical instrument passages and tubes is comprised of a length of wire formed into three segments: a first helical section, a loop section and second helical section. The two helical sections are twisted tightly together capturing bristles between the two helical sections at least near the end remote from the loop section. The finished brush consists of a loop to facilitate handling; a long double helix composed of the two helical sections intertwined; and, a portion of the double helix in which bristles are captured forming a working portion of the brush. Bristles are frequently nylon filaments of a given length captured between the wires at their centers. This creates a brush working portion with a selected bristle end to bristle end diameter.

In extremely small diameter brushes, the loop section of wire is not present and the brush consists of two intertwined helical wire sections with bristles captured between helical wire sections near one end.

Such brushes become soiled when used. Brushes are often reused. While they may be cleaned and sterilized, they contain numerous constricted spaces, particularly between the bases of adjacent bristles. This makes complete cleaning difficult.

### SUMMARY OF THE INVENTION

The present invention provides a surgical and veterinary instrument cleaning brush with improved reusability. In accordance with the present invention, a brush for cleaning medical and veterinary instruments comprising two helical lengths of steel wire formed into a double helix capturing a multiplicity of bristles is improved by using bristles having anti-bacterial properties.

Further in accordance with the invention, the bristles are anti-microbial.

Still further in accordance with the invention, the bristles are nylon based filaments containing an antimicrobial agent containing silver, zinc and glass.

Still further in accordance with the invention the brush is provided with bristles adapted to prevent the growth of certain bacteria, mold and yeasts on said bristles.

It is a principal object of the present invention to provide a surgical and veterinary instrument cleaning brush having antimicrobial properties in the brush working area.

It is still another object of the present invention to provide a surgical and veterinary instrument cleaning brush which at least retards the growth of certain bacteria, mold and yeast on the bristle surface.

It is still another object of the present invention to provide a reusable surgical and veterinary instrument cleaning brush useful in cleaning tubes and passageways in instruments which is more easily kept clean.

These and other objects of the present invention will become apparent to those skilled in the art from the following description taken in conjunction with the accompanying drawings wherein:

### BRIEF DESCRIPTION OF THE DRAWINGS

FIG. 1 is a side view of a medical and veterinary instrument brush in accordance with the present invention; and,

FIG. 2 is an enlarged view of a brush similar to the brush of FIG. 1 showing the working end of the brush only.

### PREFERRED EMBODIMENT

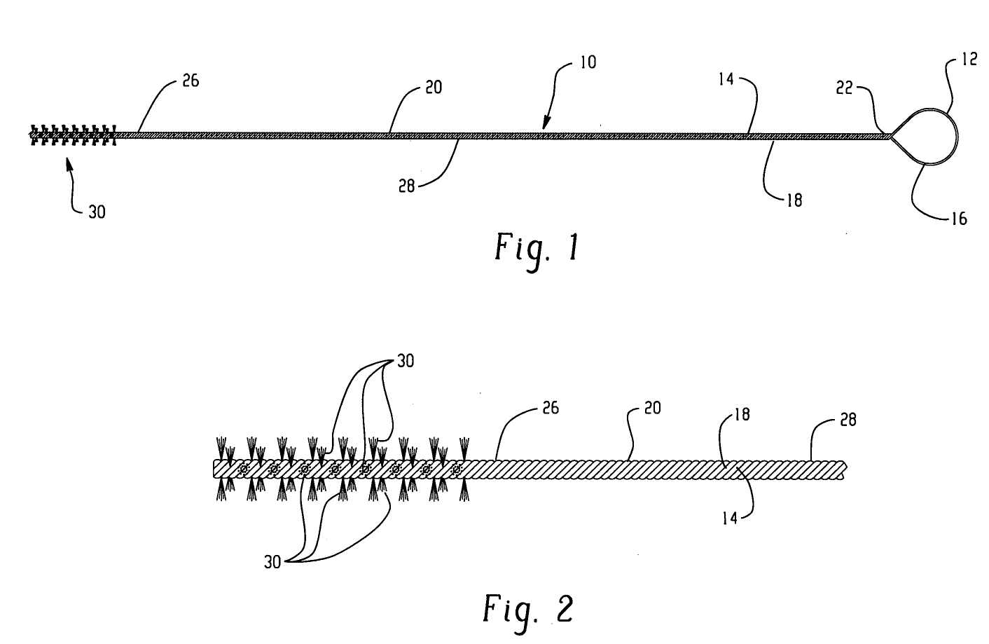

Referring now to the drawings wherein the showings are for the purposes of illustrating a preferred embodiment of the invention and not for the purposes of limiting same, FIG. 1 shows a brush 10 for cleaning surgical, medical and veterinary instruments. The brush is formed from a stainless steel wire 12 formed into a first helical segment 14, a loop segment 16 and a second helical segment 18. The helical segments 14, 18, are too fine to be seen clearly in FIG. 1 but can be seen in FIG. 2. A long, thin, double helix 20 is created by the tight intertwining of the first helical segment and the second helical segment 18. The brush consists of a handle end 22 and a working end 26. In many brushes in accordance with the invention, the handle end 22 is separated from the working end 26 by a long intermediate portion 28. The intermediate portion has no bristles.

The working end 26 has a multiplicity of bristles 30 captured between the first helical

segment 14 and the second helical segment 18. The bristles are generally fabricated from filaments having a uniform diameter and a selected equal length. However, filaments with different lengths to form a tapered brush or filaments of varying lengths to provide a profile to the brush could be used.

The brush diameter, measured from bristle tip to bristle tip, varies from 1 millimeter to 10 millimeters and larger. On smaller diameter brushes, the loop segment 16 is dispensed with and the brush consists essentially of a working end 26 and an intermediate portion 28 only. Alternatively, double ended brushes comprising two working ends containing bristles interconnected by an intermediate portion 28 are also made in accordance with the invention.

The bristles 30 forming a part of the present invention are nylon based filaments containing an inorganic silver, zinc, glass based antimicrobial agent which prevents growth of a variety of bacteria, mold and yeast on the surface of the filaments. Bactericidal activity is also provided on the surface of the bristles. The preferred filaments are available form Proveedor Mexicana de Monofilamentos S.A. de C.V. of Mexico City, Mexico under the designation Brightline Nylon-AB.

Many helical twisted wire brushes include a very large number of bristles captured between the helical segments of the wire forming the backbone of the brush. The bristles must be closely packed and captured between the first helical segment 14 and the second helical segment 16 of the stainless steel wire 12. This creates many constricted spaces and closely adjacent surfaces. These constricted spaces between adjacent bristles 30 at the point of capture between the adjacent first helical segment 14 and the adjacent second helical segment 18 create some of the smallest openings with adjacent surfaces in the brush. In the present invention, the bristle 30 surfaces in this tightly packed volume are antimicrobial providing antimicrobial properties at the position most difficult to clean and therefore most prone to problems.

While considerable emphasis has been place herein on the structure of the preferred embodiment and the structural interrelationships between component parts of the preferred embodiment, it will be appreciated that many changes in the embodiment herein illustrated and described can be made without departing from the principles of the invention. Accordingly, it is to be distinctly understood that the foregoing descriptive matter is to be interpreted as merely illustrative of the preferred embodiment and not as a limitation.

Having thus described the invention, it is claimed:

1. In a brush for cleaning surgical, medical and veterinary instruments comprising:
a length of flexible stainless steel wire formed into a first helical segment, a central loop segment and a second helical segment; a multiplicity of bristles; and, said first helical segment and said second helical segment tightly engaging one another forming a double helix having a length and capturing said bristles between said first helical segment and said second helical segment over at least a portion of said double helix length remote from said loop segment: the improvement comprising said bristles being antibacterial.

2. The improved brush of claim 1 wherein said bristles are antimicrobial.

3. The improved brush of claim 2 wherein said bristles are nylon based filaments containing an antimicrobial agent containing silver, zinc, and glass.

4. The improved brush of claim 3 wherein said brush prevents growth of certain bacteria, mold and yeast on said bristles.

5. In a brush for cleaning surgical, medical and veterinary instruments comprising:
at least one length of flexible stainless steel wire formed into a first helical segment and a second helical segment; a multiplicity of bristles; and, said first helical segment and said second helical segment tightly engaging one another forming a double helix having a length and capturing said bristles between said first helical segment and said second helical segment over at least a portion of said double helix length: the improvement comprising said bristles being antibacterial.

6. The improved brush of claim 5 wherein said bristles are antimicrobial.

7. The improved brush of claim 6 wherein said bristles are nylon based filaments containing an antimicrobial agent containing silver, zinc, and glass.

8. The improved brush of claim 7 wherein said brush prevents growth of certain bacteria, mold and yeast on said bristles.
